(19) United States
(12) Patent Application Publication
(10) Pub. No.: US 2007/0236562 A1
(43) Pub. Date: Oct. 11, 2007

(54) METHOD FOR COMBINING INFORMATION OF IMAGE DEVICE AND VEHICLE OR PERSONAL HANDHELD DEVICE AND IMAGE/TEXT INFORMATION INTEGRATION DEVICE

(76) Inventor: Ching-Shan Chang, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,808

(22) Filed: May 10, 2006

(30) Foreign Application Priority Data
Apr. 3, 2006 (TW) 95111748

(51) Int. Cl. H04N 7/18; B60Q 1/00; G08B 19/00; G08B 21/00

(52) U.S. Cl. 348/61; 340/540; 340/521; 340/425.5

(57) ABSTRACT

A method for combining information of an image device and a vehicle or a personal handheld device is provided. The method includes the following steps. First, an image information caught by the image device is provided, in which the image device is disposed on a movable carrier. Then, a text information of the vehicle or the personal handheld device and the image information are integrated to generate an output information.

### CROSS-REFERENCE TO RELATED APPLICATION

This application claims the priority benefit of Taiwan application serial no. 95111748, filed on Apr. 3, 2006. All disclosure of the Taiwan application is incorporated herein by reference.

### BACKGROUND OF THE INVENTION

1. Field of the Invention

The present invention relates to an integration method and device. More particularly, the present invention relates to a method for combining information of an image device and a vehicle or a personal handheld device and an image/text information integration device.

2. Description of Related Art

In modern life, image devices are extremely popular tools. Besides being equipped with an entertainment function, common image devices also provide a function of capturing real-time moving or still pictures. For example, a video recording lens is often installed in a dark narrow alley. In this manner, images of persons intending to commit crimes may be captured, thus achieving an effect of intimidating the criminals. Moreover, pictures recorded by the video recording lens can be provided to police to facilitate investigation.

Further, as for the use of the image device in the vehicle, when reversing, drivers cannot sense the exact distance, so the rear end of the car may easily get scratched or crashed. In order to solve the problem, some car owners have a rearview lens installed at the rear end of the car, and a display unit installed inside the car. When reversing, drivers can determine the distance depending on the pictures captured by the rearview lens and displayed by the display unit, thus preventing scratching and crashing. Definitely, the image device can also be used to record the inside/outside space surrounding of the car during driving.

However, in addition to human error, damage to the mechanical parts of the vehicle may also incur in traffic accidents. Although, at present the state of a vehicle can be acquired by installing a driver information output device on the vehicle, the driver information output device still needs an external output interface for users to read the decoded information. In other words, during driving, the driver can acquire the state of the vehicle only from the information displayed on the instrument panel, and cannot obtain the detailed state of the whole vehicle in real time.

After the occurrence of the traffic accident, the driver may use the driver and recorded image information to determine the cause of the accident and accordingly clear from the traffic accident responsibility. Although the driver information and recorded images can be found easily, it is very laborious and time consuming to retrieve the information because the image is being continuously recorded during the whole period of the driving.

### SUMMARY OF THE INVENTION

Accordingly, an objective of the present invention is to provide a method for combining information of an image device and a vehicle or a personal handheld device. The method involves integrating the image captured by the image device and the corresponding text of the vehicle or personal handheld device as a whole. Thus, when playing the image, the user can decide to whether or not to display the text in sync, so as to facilitate determining whether the event is caused by the failure of the mechanical parts or by the man-made carelessness.

Another objective of the present invention is to provide an image/text information integration device for integrating the image captured by the image device and the corresponding text of the vehicle or personal handheld device as a whole.

In order to achieve the above or other objectives, the present invention provides a method for combining information of an image device and a vehicle or a personal handheld device. The method comprises providing an image information by the image device, wherein the image device is disposed on a movable carrier, and then integrating a text information of the vehicle or the personal handheld and the image information to generate an output information in an image/text information integration device.

In an embodiment of the present invention, the image information further comprises an audio information.

In an embodiment of the present invention, the text information is a record of the state of and/or outside the body of the movable carrier.

In an embodiment of the present invention, a step of inputting the image information to an image compression unit and making the image information into a digital image data stream is accomplished before generating the output information.

In an embodiment of the present invention, the text information is obtained through converting a storage information of the vehicle or the personal handheld device by a text information converter.

In an embodiment of the present invention, a step of inputting the text information into a text information capturing unit of the image/text information integration device and making the text information into a text information data stream is accomplished before generating the output information.

In an embodiment of the present invention, the process for generating the output information comprises making the image information and the text information respectively into a digital image data stream and a text information data stream, and then inputting the digital image data stream and the text information data stream into an image/text combining unit of the image/text information integration device and integrating the image information and the text information to generate the output information in the image/text combining unit.

In an embodiment of the present invention, the process for integrating the text information and the image information into the output information comprises recording the text information inside or outside the image information.

In an embodiment of the present invention, the method for recording the text information inside the image information comprises recording the text information in a data unit of the image information.

In an embodiment of the present invention, the method for combining information of an image device and a vehicle or a personal handheld device further comprises outputting the output information by an audio-visual output unit or storing the output information in a storage unit.

In an embodiment of the present invention, the method for combining information of an image device and a vehicle or a personal handheld device further comprises using a recognition system to recognize the user, so as to limit the output of the output information.

In an embodiment of the present invention, a step of reminding the user of the output information by ringing or lightening of a warning unit is further included after generating the output information.

In an embodiment of the present invention, a key unit may be adopted for fast forward, rewind, frame-by-frame play, and slow play of the output information after generating the output information.

In an embodiment of the present invention, the text of the output information is displayed by a character display unit.

In an embodiment of the present invention, the output information is delivered to a computer via a network interface unit, such that the user can make use of the computer to monitor the output information on real time basis.

The present invention further provides an image/text information integration device, which is suitable for integrating a text information in a vehicle or a personal handheld device and an image information into an output information. The image/text information integration device comprises an image/text combining unit, an image device, and a text information capturing unit. The image device is electrically connected to the image/text combining unit, wherein the image device is suitable for providing the image information and inputting the image information into the text combining unit. The text information capturing unit is also electrically connected to the image/text combining unit, and the text information capturing unit is suitable for capturing the text information in the vehicle or the personal handheld device.

In an embodiment of the present invention, the image/text information integration device further comprises an image compression unit electrically connected between the image device and the image/text combining unit.

In an embodiment of the present invention, the image/text information integration device further comprises a text information converter electrically connected between the vehicle or the personal handheld device and the image/text combing unit, wherein the text information converter is suitable for compressing the image information into a digital image data stream.

In an embodiment of the present invention, the image/text information integration device further comprises an output unit electrically connected to the image/text combining unit, wherein the output unit is suitable for playing the output information.

In an embodiment of the present invention, the output unit comprises an audio-visual output unit, a character display unit, a warning unit, or a computer.

In an embodiment of the present invention, the image/text information integration device further comprises a storage unit suitable for storing the output information and being electrically connected to the image/text combining unit.

In an embodiment of the present invention, the storage unit comprises a hard disk drive (HDD), a flash memory, a memory card, or a tape.

According to an aspect of the present invention, the image information of the image device and the text information of the vehicle or the personal handheld device are integrated as a whole. Therefore, when playing the image, the user can decide whether or not to display the corresponding text information of the vehicle or the personal handheld device in sync, so as to determine whether the event is caused by the failure of the mechanical parts or by the human carelessness.

Moreover, since the file capacity of the image information is extremely large, it is laborious and time consuming to retrieve data only depending on the image. However, by the use of the text data of the vehicle or the personal handheld device, a quicker retrieval possible, e.g. searching for the time point of the speed of the vehicle exceeding 100 km and playing the image of the time. Therefore, the integration of the image information and the text information facilitates easy retrieval of information and is less time and labor consuming.

In order to the make aforementioned and other objectives, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a image/text information integration device according to an embodiment of the present invention.

FIG. 2 is a flow chart of a method for combining information of an image device and a vehicle or a personal handheld device according to an embodiment of the present invention.

### DESCRIPTION OF EMBODIMENTS

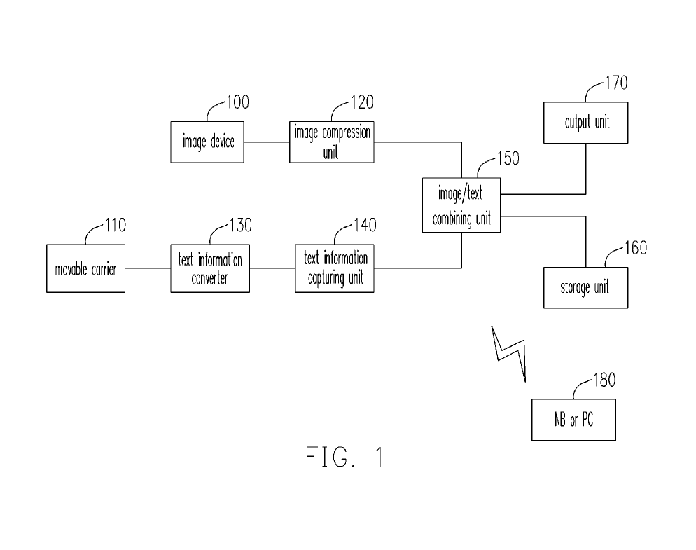

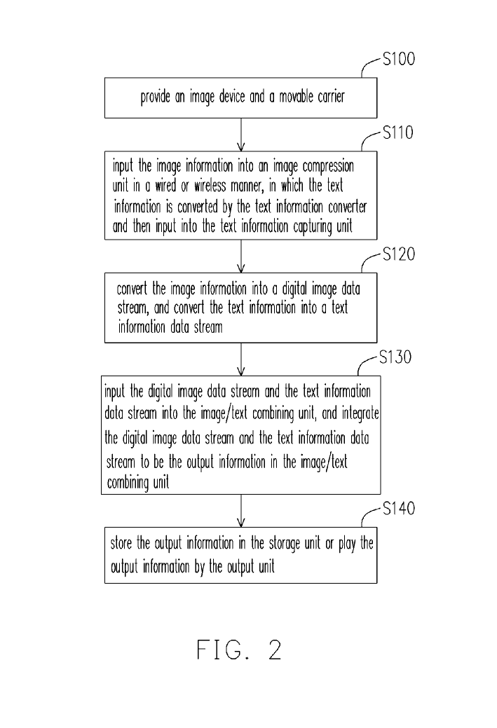

FIG. 1 is a block diagram of a image/text information integration device according to an embodiment of the present invention, and FIG. 2 is a flow chart of a method for combining information of an image device and a vehicle or a personal handheld device according to an embodiment of the present invention. Referring to FIG. 1 and FIG. 2, an image device 100 and a movable carrier 110 are provided in step S100, wherein the image device 100 is installed on the movable carrier 100 to capture or record the moving or still image of or outside the body of the movable carrier 110 and to make the image into a digital or analog image information. Moreover, the image information further includes audio information.

Accordingly, the movable carrier 110 may be a vehicle such as a car, ship, plane, bus, and train, or a person. If the movable carrier 110 is a vehicle, a driver information output device can record the state of the vehicle during driving, e.g. engine revolution, calculated load value, coolant temperature, fuel system status, vehicle speed, short term fuel trim, long term fuel trim, intake manifold pressure, timing advance, intake air temperature, air flow rate, absolute throttle position, oxygen sensor voltages/associated short term fuel trims, fuel pressure, water temperature, feedback control value, O₂ sensor monitor test, driver computer information, catalyst converter and the heating function thereof, misfire monitor, oil gas evaporation system, secondary air intake system, monitor of O₂ sensor, exhaust gas recirculation (EGR) system, positive crankcase ventilation (PCV) system, and other internal state of the related exhaust control elements. Moreover, the text information may also include a record of the humidity, temperature, or global positioning position, and so on outside the body of the vehicle.

Further, if the movable carrier 110 is a person, the state of or outside the body of the person can be recorded by wearing personal handheld devices such as sphygmograph, pedometer, heart rate monitor, and hygrometer. It should be noted that the state of or outside the body recorded by the driver information output device 110 or the personal handheld device is a text information recorded in the form of text. Alternatively, the personal handheld device can be a GPS installed in the vehicle.

Next, in step S110, the image information is input to an image compression unit 120 in a wired manner such as using RJ45, USB, 1384, or cable, or in a wireless manner such as using WIFI, WiMAX, RF, Bluetooth, Irda, GSM, GPRS, or CMDA. The text information is converted by the text information converter 130, and then input into the text information capturing unit 140, wherein the text information converter 130 is electrically connected between the vehicle or the personal handheld device and the text information capturing unit 140.

Next, in step S120, after the image information and the text information are respectively input into the image compression unit 120 and the text information capturing unit 140, the image information is converted into a digital image data stream, and the text information is converted into a text information data stream.

Next, in step S130, the digital image data stream and the text information data stream are input into the image/text combining unit 150 so as to be integrated to generate the output information therein. In the present embodiment, the method for integrating the digital image data stream and the text information data stream into the output information involves storing the text information inside or outside the image information. Taking the text information stored in the JPEG image as an example, the JPEG comprises many units, wherein a type of unit is called as an application unit. The length of the application unit can be determined as desired, and the text information can be input to the application unit. Specifically, the structure of the application unit is marked number+unit+data content, wherein the data content is the text information stored in the image information. According to the manner of storing the text information inside the image information, although the text information is additionally stored in the image information, the storing process does not affect the data format of the image.

Taking storage of the text information outside the image information as an example, storing outside the image information means reserving a storage space outside the image information, and storing the text information corresponding to the image information therein.

Next, in step SI 40, the output information is stored in the storage unit 160, wherein the storage unit 160 is electrically connected to the image/text combining unit 150. In the present embodiment, the storage unit 160 can be an HDD, a flash memory, a memory card, or a tape. Definitely, the output information can be played by the output unit 170, and the output unit 170 is electrically connected to the image/text combining unit 150. The output unit 160 of the present embodiment can be the audio-visual output unit for displaying the audio-video and the text in sync, the character display unit only displaying the text, the warning unit being capable of lightening or ringing, or the computer.

In addition, in order to protect the output information to avoid the data leakage, a recognition system can be used to recognize the user. Particularly, after the recognition system confirms the user, the output information is output to the storage unit 160 or to the output unit 170 for playing.

Further, since the image information captured by the image device 100 is extremely large, for the convenience of retrieving the image data, an information index area can be built inside or outside of the image information so as to store the text information. For example, when the user intends to search for the state of the inside mechanical parts of the vehicle with a speed exceeding 100 km or the road condition outside, the image information corresponding to the text information can be retrieved from the information index area through setting one or more setting conditions, which is quite convenient for the user. Further, when the output unit 170 is used to play the output information, the key unit (not shown) can be used to control the playing of the image such as fast forward, rewind, frame-by-frame play, slow motion play, play on demand.

Definitely, the method and the device of the present invention also have a real-time monitor function. For example, the output information can be delivered to a notebook computer or personal computer through the network interface in wireless manner. Therefore, external users can see the real-time picture and information.

To sum up, the method for combining information of an image device and a vehicle or a personal handheld device and image/text combining device of the present invention have at least the following advantages.

1. During the playing of the image, the corresponding text information can be selectively displayed in sync. Therefore, it facilitates the determination of cause of the event.

2. It is advantageous for the user to quickly retrieve the image/text information by setting conditions.

3. A standalone operation is possible without using external computers or other devices, thus acquiring the real-time image and information.

4. The PC terminal software can be used to monitor the real-time image and information.

5. Due to the wide field of application, the function of real-time monitoring can be applied in the vehicle or the outgoing for exercise or the state of living for the individual, so as to real-time act or remedy when an event happens.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for combining information of an image device and a vehicle or a personal handheld device, comprising:
providing an image information by the image device disposed on a movable carrier; and
integrating a text information from the vehicle or the personal handheld and an image information to generate an output information in an image/text information integration device.

2. The method for combining information of an image device and a vehicle or a personal handheld device as claimed in claim 1, wherein the image information further comprises audio information.

3. The method for combining information of an image device and a vehicle or a personal handheld device as claimed in claim 1, wherein the text information is a record of the state of and/or outside the body of the movable carrier.

4. The method for combining information of an image device and a vehicle or a personal handheld device as claimed in claim 1, further comprises inputting the image information into an image compression unit and making the image information into a digital image data stream before generating the output information.

5. The method for combining information of an image device and a vehicle or a personal handheld device as claimed in claim 1, wherein the text information is obtained through converting a stored information of the vehicle or the personal handheld device using a text information converter.

6. The method for combining information of an image device and a vehicle or a personal handheld device as claimed in claim 1, further comprises inputting the text information into a text information capturing unit of the image/text information integration device and making the text information into a text information data stream before generating the output information.

7. The method for combining information of an image device and a vehicle or a personal handheld device as claimed in claim 1, wherein the method for generating the output information comprising:
making the image information and the text information respectively into a digital image data stream and a text information data stream; and
inputting the digital image data stream and the text information data stream into an image/text combining unit of the image/text information integration device, and integrating the image information and the text information to generate the output information in the image/text combining unit.

8. The method for combining information of an image device and a vehicle or a personal handheld device as claimed in claim 1, wherein the process for integrating the text information and the image information into the output information comprises recording the text information inside or outside the image information.

9. The method for combining information of an image device and a vehicle or a personal handheld device as claimed in claim 8, wherein the process for recording the text information inside the image information comprises recording the text information into a data unit of the image information.

10. The method for combining information of an image device and a vehicle or a personal handheld device as claimed in claim 1, further comprising outputting the output information by an audio-visual output unit, or storing the output information in a storage unit.

11. The method for combining information of an image device and a vehicle or a personal handheld device as claimed in claim 1, further comprising using a recognition system to recognize the user, so as to limit the output of the output information.

12. The method for combining information of an image device and a vehicle or a personal handheld device as claimed in claim 1, further comprising reminding the user of the output information by ringing or flashing light of a warning unit after generating the output information.

13. The method for combining information of an image device and a vehicle or a personal handheld device as claimed in claim 1, further comprising using a key unit to fast forward, rewind, frame-by-frame play, and slow motion play the output information after generating the output information.

14. The method for combining information of an image device and a vehicle or a personal handheld device as claimed in claim 1, wherein the text of the output information is displayed by a character display unit.

15. The method for combining information of an image device and a vehicle or a personal handheld device as claimed in claim 1, wherein the output information is delivered to a computer via a network interface unit, so as to make use of the computer to real-time monitor the output information.

16. An image/text information integration device, suitable for integrating a text information of a vehicle or a personal handheld device and an image information into an output information, comprising:
an image/text combining unit;
an image device electrically connected to the image/text combining unit, wherein the image device is suitable for providing the image information, and inputting the image information to the image/text combining unit; and
a text information capturing unit electrically connected to the image/text combining unit, wherein the text information capturing unit is suitable for capturing the text information of the vehicle or the personal handheld device.

17. The image/text information integration device as claimed in claim 16, further comprising an image compression unit electrically connected between the image device and the image/text combining unit and being suitable for compressing the image information into a digital image data stream.

18. The image/text information integration device as claimed in claim 16, further comprising a text information converter electrically connected between the vehicle or the personal handheld device and the image/text combing unit and being suitable for converting the text information to a text information data stream.

19. The image/text information integration device as claimed in claim 16, further comprising an output unit electrically connected to the image/text combining unit and being suitable for playing the output information.

20. The image/text information integration device as claimed in claim 19, wherein the output unit comprises an audio-visual output unit, a character display unit, a warning unit, or a computer.

21. The image/text information integration device as claimed in claim 16, further comprising a storage unit electrically connected to the image/text combining unit and being suitable for storing the output information.

22. The image/text information integration device as claimed in claim 21, wherein the storage unit comprises a hard disk drive (HDD), a flash memory, a memory card, or a tape.
